(19) United States
(12) Patent Application Publication
(10) Pub. No.: US 2010/0289877 A1
(43) Pub. Date: Nov. 18, 2010

(54) METHOD AND EQUIPMENT FOR PRODUCING AND DISPLAYING STEREOSCOPIC IMAGES WITH COLOURED FILTERS

(76) Inventors: Christophe Lanfranchi, Cormeilles En Parisis (FR); Christophe Brossier, Le Perreux Sur Marne (FR)

Correspondence Address: Baker Donelson Bearman, Caldwell & Berkowitz, PC, 920 Massachusetts Ave, NW, Suite 900, Washington, DC, 20001, US

(21) Appl. No.: 12/665,415

(22) PCT Filed: Jun. 2, 2008
(86) PCT No.: PCT/EP08/56798

§ 371 Date: Jun. 5, 2010

(30) Foreign Application Priority Data
Jun. 19, 2007 (FR) 07/04360

(51) Int. Cl. H04N 15/00

(52) U.S. Cl. 348/46; 348/E15.001

(57) ABSTRACT

A method for viewing a sequence of images producing a relief sensation is provided.

### TECHNICAL FIELD

The present invention relates to the field of production and viewing of stereoscopic images. Generally, the invention relates to a method and equipment with which relief images may be reconstructed, from any stereoscopic source (real shots, synthetic images), on any two-dimensional color display medium, notably and in a non-limiting way, on a TV-CRT screen, a liquid crystal screen, a plasma screen, an electronic projection, a projection from a silver or digital film.

Relief viewing, i.e. this ability of seeing the world with immediate sensation of depth and of volume, requires binocular vision. Thus, each eye may see a same subject from a slightly shifted viewpoint relatively to the other eye. It is this shift in viewpoint which allows the brain, by analyzing differences between the right and left images, to interpret the depth, the distance, of an observed subject. This is called stereoscopic vision.

In order to reproduce this stereoscopic vision in photography, on television or at the cinema, different more or less complex methods have been invented.

Among the latter, an ancient and popular method, known as anaglyph, uses spectacles consisting of two colored filters of opposite colors, also described as complementary colors according to the trichromatic theory of colors. The pairs of filters customarily used by the anaglyph method are either red and blue or red and green or red and cyan or magenta and green or yellow and blue.

The spectator, equipped with anaglyph spectacles, looks at a single image built by superposing by additive synthesis the right and left images of the stereoscopic pair, respectively filtered with the colors used for the right and left filters of the spectacles. From a certain point of view, it may be stated that the relief is contained in the color of this single two-dimensional image.

The anaglyph method has the great advantage of being able to be displayed on any 2-D color display system. It is this simplicity of broadcasting which has made this method so popular since its invention in 1853 by Rollman.

On the other hand, it has serious drawbacks as regards vision comfort and integrity of the observed colors. Indeed, the effort by the brain functions required for merging the colors of the right image with those of the left image is too significant for exceeding a few minutes of observation. After this delay, most observers feel tired or have headaches. Further, if theoretically, the right and left colored images should, by being reconstructed, restore the true original color, in fact, the visual functions of the eyes-cortex pair do not allow this. Instead, the observer sees images, the colors of which are changed. For example in the case of the most popular pair of anaglyph filters, the red/cyan pair: red wavers within the same second between orange/brown and black, the faces of the actors become livid, whites waver between undecidable colors, now pink now turquoise.

Under these conditions, it is not surprising that anaglyph images appear as a gadget in the mind of the general public and that after a few minutes of interest, attention is diverted under the burden of discomfort.

### STATE OF THE ART

In the state of the art, different solutions are known with which stereoscopic images may be restored.

One of the widespread solutions for stereoscopic diffusion operates on the principle of anaglyph filters. This economical solution however has different drawbacks which have prevented adhesion of the public and of the content distributors.

Five conditions are indeed required for this adhesion:

1. Relief vision comfort without tiring the brain, comprising an equal distribution of the brightness between each eye and low rivalry of binocular chromatic contrast.

2. Observance of the original colors of the work most particularly for flesh tones and neutral tones.

3. Pleasant relief without interfering ghost images.

4. Suitability for any type of stereoscopic content regardless of the method for producing the images and the relief parameters used.

5. Operability on different types of screen technologies, for example: CRT, LCD, Plasma, 3LCD, 1DLP, 3DLP projection, silver film.

It appears that the known solutions of the prior art do not allow these conditions to be met completely. In order to remedy the drawbacks of the solutions of the prior art, the invention proposes a solution in several steps which consist of:
fitting out the observer with spectacles including colored filters which do not comply with the standard anaglyph principle. Indeed, the proposed filters are of complementary colors with the particularity, for at least one of them, of transmitting a small portion of the colorimetric spectrum of the opposite filter. This is contrary to the approach of one skilled in the art aware of the anaglyph method which consists of exclusively presenting to each eye the image which is intended for it. One of the advantages of the invention relatively to the anaglyph principle is to improve the colorimetric rendering for the observer.
determining a pair of colored filters allowing optimum observance of colorimetric rendering.
refining said rendering by non-linear colorimetric processing of the stereoscopic images.
correcting certain saturated colors which may have a slight discomfort.
minimizing the formation of ghost image effects (promoted by said filters) below the perception threshold of the observer placed at a relative reference distance, by parameterizing in a particular way the adjustments of the staging of the relief during stereoscopic shots and/or by acting in postproduction by image processing operations dependent on the Z coordinate of each pixel (such as: change in disparity, generation of blurring, contrast modification).

The thereby obtained relief is more subtle while remaining sufficient for providing a pleasant experience to the observer.

This method, object of the invention, relates to all the devices allowing production of a sequence of pairs of stereoscopic images, such as stereoscopic shots with a camera system allowing the capture of at least two different viewpoints, such as for example: camera systems with 2 distinct sensors, mono-sensor cameras with mono-objective or bi-objective binocular separation. In the state of the art, a method commonly called relief enhancement or 2D-3D conversion, involving shooting with a single camera filming a single viewpoint followed by a postproduction operation aiming at reconstructing the second stereoscopic point of view by various manual and/or automatic techniques. The term “shooting” is meant either in the real world, or by computer synthesis, for example for synthetic images.

For video games and generating interactive synthetic images, an automatic parameterization method of the stereoscopic rendering depending on the limitations of the invention is also described.

The advantage of this invention relatively to the prior art is relief-viewing comfort, without tiring the brain, as well as true restoration of the colors of the original two-dimensional version, except for certain saturated colors.

Terminology:

Within the scope of the present patent, the technical terms used will be understood as follows:

A) Cinematography:

Shooting: by shooting is meant real captures on a film medium or digital medium, and captures in synthetic images (for example in a video game or in a cartoon film).

Sequence: a sequence is a succession of animated images including a succession of shots. For example, a cinematographic film, a TV film, a video clip, a documentary film, a report, a cartoon, including several shots, are therefore sequences.

Shot: used in its time sense, the shot designates a succession of animated images expressing continuity of action without cutting. Used in its spatial sense, foreground and background are used for designating the elements respectively close to or distant from the camera system.

Maximum attention point: the area which the spectator mainly watches, typically the location where the action occurs, for example the face of the actor who is speaking.

B) Relief and Stereoscopy:

Relief vision of binocular vision: human relief vision is possible with the two different images of the objects which are formed on the retina of each of our eyes, a complex innate reflex physiological activity, relying on the accommodation-convergence of both eyes, which gives the sensation of 3D relief and the sense of space.

Stereoscopic merging: stereoscopic merging is when the brain reconstructs a single image from the perception of two plane and different images from each eye. There exists a large variety of means for producing these images, as well as for observing them.

Stereoscopy: from the Greek stereo, solid, and scope, vision, stereoscopy is the whole of the techniques applied for reproducing a sensation of relief from two plane images called a stereoscopic pair. It was born shortly after the invention of photography.

Stereoscopic base: this is the distance which separates the nodal points of the two objectives of a stereoscopic shooting system. The relief sensation of the observer is proportional to the stereoscopic base.

Z coordinate: the Z coordinate characterizes the relief of each pixel (X and Y representing the 2-dimensional coordinates). It may be calculated by measuring the disparity of said pixel between the two images of the stereoscopic pair (digital photogrammetry). Z may be negative or positive depending on the sense of the measured disparity (negative in depth behind the plane of the screen or positive upon protruding out in front of the plane of the screen).

Convergence: convergence is the operation which consists when stereoscopic shooting is carried out with two objectives, of having the optical axis of said objectives horizontally converge on the subject which will be located for the observer on the plane of the screen (neither protruding, nor in depth), during the stereoscopic broadcasting of the images. If no convergence adjustment is applied during the shooting, i.e. if the axis of the objectives is parallel, the totality of the captured scene will be protruding out, in front of the plane of the screen, during broadcasting of the images.

Collimation: collimation is an operation which simulates or corrects the convergence of two cameras after producing a stereoscopic sequence. This postproduction operation consists of horizontally shifting both images of a stereoscopic pair one relatively to the other. This operation has the effect of moving the relief image forwards or backwards relatively to the plane of the screen during stereoscopic merging. The homologous points of both images which are found positioned at the same location on the screen, will be positioned in relief exactly on the plane of the screen. From the right and left images, only the superposed portions should be retained, which causes a horizontal reduction in the size of the images of the stereoscopic pair. In order to retain the initial image ratio, it is either suitable to horizontally enlarge the images by a sufficient coefficient, or, if losing a little of the image at the top and/or at the bottom of the frame is accepted, to carry out reframing to the original ratio, followed by homothetic enlargement in order to obtain the exact original format.

Local collimation: this is a horizontal shift made on an element present in both images of a stereoscopic pair. This element will have been extracted beforehand from at least one of the two images of the stereoscopic pair. Local collimation reduces or increases the stereoscopic disparity at this element.

Disparity or stereoscopic disparity: this is the horizontal distance separating two homologous points of a pair of stereoscopic images, visible without any filtering spectacles, measured on the display screen when both images are superposed. This distance may be expressed in pixels for digital images, it may also be measured as a fraction of the width of the image. Adjustment of convergence or collimation changes in a substantially uniform way the stereoscopic disparity of all the points of the image pair. Adjustment of the stereoscopic base acts non-linearly on the stereoscopic disparity of all the points of the image pair.

Maximum stereoscopic disparity: this is the highest stereoscopic disparity among all the points of a pair of stereoscopic images.

Inter-pupillary distance: this is the distance separating the centers of both pupils of the eyes of a person when the staring point is at infinity.

Ghost image: a stereoscopic viewing device should have at each of our two eyes exclusively the image which is intended for it. The term of ghost images is used when the device is not perfect and lets through for one eye a portion of the image intended for the other eye. This bothersome phenomenon for the observer is detrimental to the quality of the restored relief. With a viewing method such as the one described in the present patent, ghost images assume the shape of colored borders, with the hue of either one of the colors used for the filters of the spectacles, which are more or less wide depending on the amount of relief of the elements, and more or less blurred depending on the sharpness of the elements.

Photogrammetry: photogrammetry is a measurement technique for which the coordinates in three dimensions of the points of an object are determined by measurement made on two photographic images (or more) taken from different positions. In this technique, the homologous points are identified on each image. A line of sight (or ray) may be built from the position of the photographic device to the point of the object. This is the intersection of its rays (triangulation) which determines the three-dimensional position of the point.

Stereoscopic morphing: stereoscopic morphing is a technique which allows restoration of any intermediate point of view between both images of a stereoscopic pair by analyzing the disparity of each pixel.

C) Colorimetry:

Subtractive synthesis: subtractive synthesis is the operation consisting of combining the effect of absorption of several colors in order to obtain a new color therefrom. In subtractive synthesis, the primary colors generally used are three in number: cyan, yellow and magenta. Addition of these three colors gives black, absence of color is white, by two-by-two addition of these primary colors secondary colors may be obtained: cyan and yellow give green, cyan and magenta give blue, yellow and magenta give red. Typically, observation through a colored filter is the matter of subtractive synthesis.

Additive synthesis: additive synthesis is the operation consisting of combining the light of several colored emitting sources in order to obtain a new color. In additive synthesis, the primary colors generally used are three in number: red, green and blue. Addition of these three colors gives white, absence of color gives black, by two-by-two addition of these primary colors, secondary colors may be obtained: red and green give yellow, red and blue give magenta, blue and green give cyan.

Complementary colors: two complementary colors are two colors which by additive synthesis give white and by subtractive synthesis are cancelled, giving black. Examples of complementary colors: red and cyan, magenta and green, blue and yellow.

Hue: a hue is the pure form of a color, i.e. without adjunction of white or black which allows its shades to be obtained. The hues are viewed on the perimeter of a chromatic wheel. This is also the attribute of the visual sensation which has given rise to the names of colors such as: blue, green, yellow, red, purple, etc.

Saturation: saturation is the property of a color which characterizes the intensity of its specific hue. It is based on the purity of the color; a highly saturated color has a bright and intense color while a less saturated color appears duller and grey. This is also the attribute of the visual sensation allowing estimation of the proportion of chromatically pure color contained in the total sensation.

Brightness: visual sensation of luminosity.

### LIST OF THE FIGURES AND DETAILED DESCRIPTION

The invention will be better understood upon reading the following description of a preferential embodiment of the invention, given as an indicative and non-limiting example, and of the appended drawings, wherein:

FIG. 1 illustrates the superposed curves of spectral transmission of a pair of preferential filters, one with a predominating color magenta (A), the other one with a predominating color green (B). (X) represents the wavelengths in nanometers and (Y) the transmission as a percentage.

FIG. 2 illustrates the superposed curves of spectral transmission of a pair of preferential filters, one with a predominating color red (C), the other one with a predominating color cyan (D). (X) represents the wavelength in nanometers and (Y) the transmission as a percentage.

FIGS. 3, 4, 5, 6 represent, as seen from above, examples of observers (1000) A, B or C, provided with spectacles according to the invention (1001), each placed at a variable observation distance DO, in front of a same stereoscopic sequence of single images according to the invention (1002), displayed in variable width L. The whole forms a comparative range of the notion of relative distance DR.

FIG. 7a illustrates the left image of a pair of stereoscopic images formed by FIGS. 7a and 7b.

FIG. 7b illustrates the right image of a pair of stereoscopic images formed by FIGS. 7a and 7b.

FIG. 8a illustrates the image of FIG. 7a after colored filtering of the cyan or green type.

FIG. 8b illustrates the image of FIG. 7b after colored filtering complementary to the filtering used for FIG. 8a, typically red or magenta.

FIG. 9 illustrates the construction and the display of a single image by superposing the images of FIGS. 8a and 8b with additive synthesis.

FIG. 10 illustrates a convergence or collimation operation applied on the pair of stereoscopic images of FIGS. 7a and 7b, followed by the building of a single image. In this example, the circle in the foreground is located at the convergent point of the optical axes.

FIG. 11a illustrates a convergence or collimation operation applied on the pair of stereoscopic images of FIGS. 7a and 7b, followed by a reduction of the depth of field (with an intensity above that of FIG. 11c) either by adjustment upon shooting or during postproduction by blurring the disparity areas, followed by the construction and display of said single image.

FIG. 11b illustrates a convergence or collimation operation applied on the pair of stereoscopic images of FIGS. 7a and 7b, followed by a stereoscopic base reduction either by adjustment upon shooting or during postproduction by calculating a virtual base, followed by the construction and display of said single image.

FIG. 11c illustrates the same chain of operations than FIG. 11b with the difference that before the construction and display of the single image, the depth of field has been reduced (with an intensity below that of FIG. 11a) or by adjustment upon shooting or during postproduction by blurring the disparity areas.

FIGS. 12a, 12b and 12c illustrate the same chain of operations as in FIG. 11c with the difference that before the construction and display of the single images 12a, 12b and 12c, the contrast of the disparity areas of bright and/or dark luminosity has been minimized.

FIG. 13 illustrates the superposed curves of spectral transmission of a pair of preferential filters, enhanced relatively to the filter illustrated in FIG. 1, one with predominating color magenta (A), the other one with a predominating color green (B), wherein (X) represents wavelengths in nanometers and (Y) the transmission as a percentage.

The invention according to its most general acceptance relates to a method for viewing a sequence of images producing a sensation of relief, including:
a step for producing a sequence of pairs of stereoscopic images,
a step for constructing a sequence of single images consisting of calculating from each of said pairs of stereoscopic images, a viewing image superposing by additive synthesis the first image to which is applied chromatic filtering and the second image to which is applied chromatic filtering complementary to the first filtering,
a displaying step on a viewing screen, said viewing screen being observed through spectacles including:
a first filter, function of the chromatic components of said first chromatic filtering,
and a second filter, function of the chromatic components of said second chromatic filtering,

at least one of the filters transmits a small proportion of chromatic components of the other filter.

said sequence of pairs of stereoscopic images represents a diversity of filmed situations where at least one of the distances between the shooting camera system, the subject of the foreground and the most distant shot varies,

said production and/or construction step further comprises, for each of the pairs of stereoscopic images of said sequence, by adjustment and/or by calculation, local and/or global adjustment, on at least one of the parameters formed by the stereoscopic disparity, the sharpness, the blurring, and the light contrast,

in order to minimize the ghost image effects below the perception threshold of the observer equipped with said filtering spectacles when said observer, looking at said sequence of single images, is placed at a relative reference distance below which ghost image effects appear,

said relative reference distance being substantially constant for the whole duration of said sequence,

said observer having good visual acuity, without any colorimetric defect.

A) Selections of the Colored Filters:

According to a first alternative, one of the filters of said spectacles is a filter comprising spectral transmission with predominance of green and the other filter is a filter comprising spectral transmission with predominance of magenta.

According to a second alternative, one of the filters of said spectacles is a filter comprising a spectral transmission with predominance of cyan and the other filter is a filter comprising a spectral transmission with predominance of red.

Advantageously, one of the filters of said spectacles comprises a spectral transmission in the area around 620 nanometers representing 5% to 18% of the transmission of the opposite filter in the same area.

Advantageously, one of the filters of said spectacles comprises a spectral transmission in the area around 520 nanometers representing 5% to 18% of the transmission of the opposite filter in the same area.

Advantageously, each of the filters transmits a small proportion of the chromatic components of the other filter.

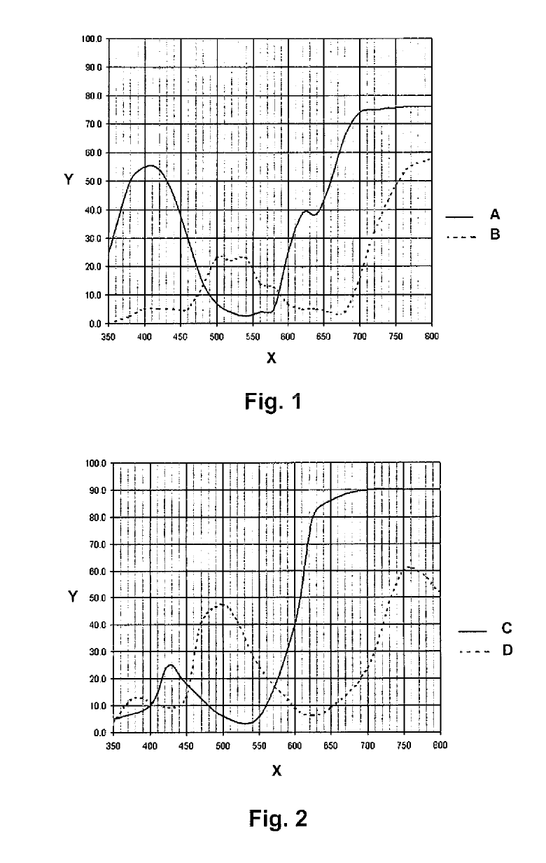

According to a preferred embodiment, the spectral transmission curve of each of the filters of said spectacles substantially corresponds to FIG. 1.

According to another alternative, the spectral transmission curve of each of the filters of said spectacles substantially corresponds to FIG. 2.

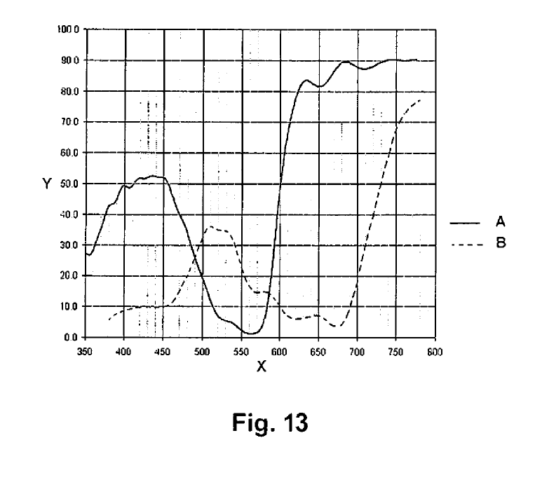

According to another alternative, enhanced relatively to the embodiment illustrated by FIG. 1, the spectral transmission curve of each of the filters of said spectacles substantially corresponds to FIG. 13.

The invention applies pairs of colored filters which have two constraints which are contradictory with each other:

1. Ensure sufficient chromatic selection so as to allow stereoscopic merging of the images processed according to the method.

2. Ensure rendering of the colors in stereoscopic vision close to natural vision, most particularly for flesh tones and neutral tones.

Unexpectedly, it is seen that when at least one of the filters transmits a small portion of the colorimetric spectrum of the opposite filter, general colorimetric perception of the observer is improved in proportions much higher than what might have been expected.

This improvement varies depending on the colors used for the filters.

The improvement is more significant when the filter with predominance of green or cyan transmits a little red than when the filter with a predominance of magenta or red transmits a little green. This result is still better when this principle is applied on each of the right and left colored filters.

The improvement is significant for the filter with predominance of green or cyan, illustrated in FIG. 1 or 13, when its transmission in the area around 620 nm represents 5% to 18% of the transmission of the opposite filter in the same area.

Improvement is significant for the filter with a predominance of magenta or red, illustrated in FIG. 2, when its transmission in the area around 520 nm represents 5% to 18% of the transmission of the opposite filter in the same area.

The selected filters are, by successive approximations with test images, the combinations of filters which have the best compromises between stereoscopic selection and restoration of the colors.

For the filter with a predominance of green (FIG. 1) the significant points of the spectral transmission curve are 5% at 450 nm, 23% at 520 nm and 5% at 620 nm.

For the filter with a predominance of magenta (FIG. 1), the significant points of the spectral transmission curve are 4% at 450 nm, 3% at 520 nm and 38% at 620 nm.

For the filter with a predominance of red (FIG. 2), the significant points of the spectral transmission curve are 12% at 450 nm, 7% at 520 nm and 75% at 620 nm.

For the filter with a predominance of cyan (FIG. 2), the significant points of the spectral transmission curve are 18% at 450 nm, 47% at 520 nm and 2% at 620 nm.

For the filter with a predominance of green (FIG. 13), the significant points of the spectral transmission curve are 10% at 450 nm, 35% at 520 nm and 10% at 600 nm.

For the filter with a predominance of magenta (FIG. 13), the significant points of the spectral transmission curve are 52% at 450 nm, 7% at 520 nm and 78% at 620 nm.

Advantageously, the pairs of filters with a predominance of magenta and green will be preferred, which give better results than the pairs of filters with a predominance of cyan and red. They are more respectful of the colors notably in flesh tones and in blue tones. Their more balanced spectral distribution is much less a strain on the visual system of the observer during prolonged use.

The manufacturing of such filters may be obtained for example by means of the so-called “thin layer deposition” technique.

It may also be obtained with flexible, transparent, chemically colored filters. Such filters are notably found under the brands of LEE-FILTERS or ROSCO.

For example:
for the filter with a predominance of magenta (FIG. 1): superposition of a filter of reference 4790 (ROSCO) and of a filter of reference 4715 (ROSCO).
for the filter with a predominance of green (FIG. 1): superposition of two identical filters of reference 243 (LEE-FILTER), of a filter of reference 245 (LEE-FILTERS), of a filter of reference 159 (LEE-FILTERS) and a filter of reference 298 (LEE-FILTERS).
for the filter with a predominance of red (FIG. 2): the filter of reference 148 (LEE-FILTERS).
for the filter with a predominance of cyan (FIG. 2): superposition of four identical filters of reference 730 (LEE-FILTERS).
for the filter with a predominance of magenta (FIG. 13): the filter of reference 328 (LEE-FILTERS).
for the filter with a predominance green (FIG. 13): superposition of three filters of reference 243 (LEE-FILTERS), 242 (LEE-FILTERS) and 223 (LEE-FILTERS).

B) Colorimetric Corrections

Creation and application of a colorimetric correction table.

During various attempts for developing an ideal pair of colored filters, it was shown that it would be difficult to attain by simply selecting or adding colored filters, an improved pair of filters with which comparable colorimetric rendering may be obtained with and without spectacles.

In order to achieve this goal, non-linear colorimetric correction is applied in two steps:
a colorimetric conversion table (LUT: Look Up Table) is created by selecting a representative sample of colors from the possible colors, notably comprising grey levels and flesh tones, and by associating with each of them, the corrected color observed through the spectacles, which is the closest to them. These values will then be used as a basis for extrapolating the corrections to the whole of the possible colors. It should be noted that every time the operator responsible for these colorimetric corrections puts on or takes off his/her spectacles, the latter will have to wait for several tens of seconds before recovering stable vision of colors. This phase will therefore be advantageously entrusted to an experienced operator in the field of color such as a colorist calibrator who will know how to keep in mind the sensation of the sought color.
the thereby obtained colorimetric conversion table will then be applied to all images of stereoscopic pairs of the sequence before construction of said single images.

According to an embodiment, said production and/or construction step further includes a non-linear colorimetric correction in order to recover after constructing said sequence of single images, with said spectacles, perception of colors as close as possible to those visible without said spectacles on the two-dimensional version of the original images.

Other colorimetric problems may however occur after the first colorimetric correction directed to recovering the original colors of the work. Indeed, certain saturated colors, in particular red, bright orange, bright pink, even if they are perfectly recognizable, may appear at some moment as uncomfortable to look at. This phenomenon is called “binocular chromatic contrast rivalry”. The latter occurs for an observer equipped with spectacles according to the invention when a saturated color or a set of points of shades of saturated colors, noted as C1, appear clearly paler for one eye than for the other.

In order to solve this problem, C1 should either be modified globally or locally. This operation is carried out on both images of the stereoscopic pair before constructing said single image. The modifications made will depend both on artistic and technical choices.

Accordingly, the operator acts in the following way:
he reduces the saturation of C1 until rivalry is acceptable.
and/or he shifts the hue of C1 towards another less awkward hue.
and/or he changes the luminosity of C1 until said rivalry is acceptable.
and/or he changes the colors in the close vicinity of C1 in order to make C1 more bearable, this is notably the case when C1 has to be preserved for artistic reasons.

For example, these operations may be carried out simply with a color calibration system such as the Lustre (trade name) of the Discreet corporation or Baselight (trade name) of the Filmlight corporation.

According to another embodiment, said production and/or construction step further includes a colorimetric correction of certain colors directed to reducing their saturation and/or changing their hue and/or changing their luminosity in order to make them more comfortable to look at after construction of said sequence of single images with said spectacles.

C) Relative Reference Distance:

The selection of a pair of colored filters according to the invention certainly allows improvement in colorimetry but as compensation, it generates the presence of ghost images detrimental to the sought sensation of relief. The solution applied in this invention for circumventing this problem was to develop a new process: anti-ghost calibration.

This consists of parameterizing in a particular way the adjustments of the staging of the relief during stereoscopic shots and/or acting during postproduction by means of image processing operations.

The ratio between an observation distance DO and the width L of the image displayed on the viewing screen is called the relative distance DR:

DR=DO/L

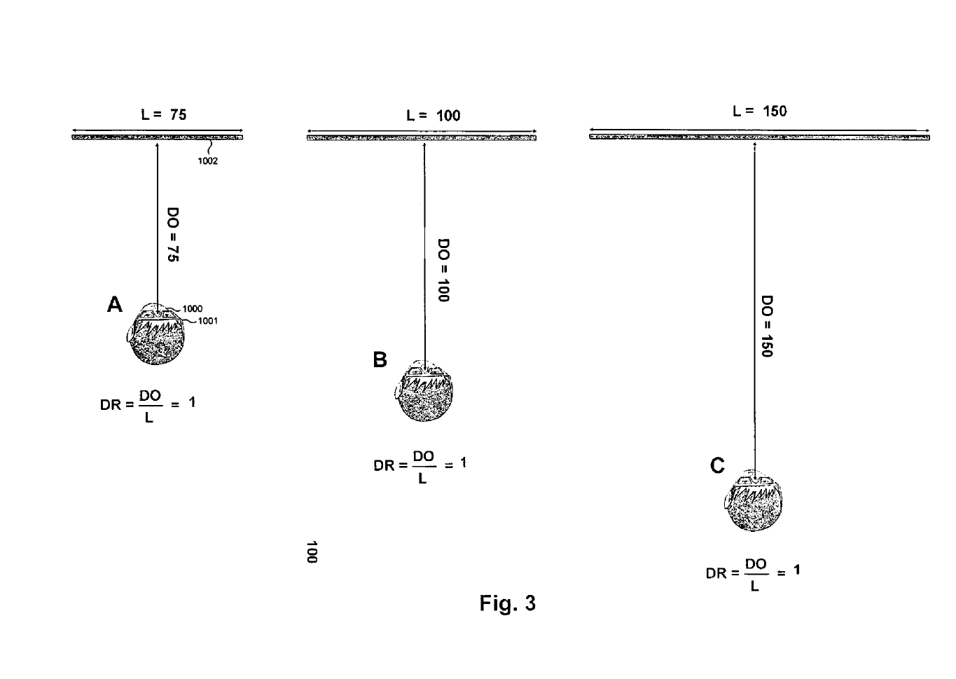

For example a relative distance of 1 means that the observer is located at once the width of the image (see FIG. 3).

The relative distance selected during said calibration is called the relative reference distance.

Regardless of the filmed situations where at least one of the distances between the camera system, the subject of the foreground and of the most distant shot varies during said sequence, the anti-ghost calibration minimizes on the single image, the ghost image effect below the perception threshold of the observer (spectator) provided with said filtering spectacles, located at the relative reference distance.

The consequence of this anti-ghost calibration is a diminished relief thickness accompanied by a more restricted latitude in observation distance (compatible with a sensation of relief without any ghost-image effect) in comparison with other stereoscopic diffusion methods such as with for example standard anaglyph spectacles, polarizing spectacles or electronic shutter spectacles.

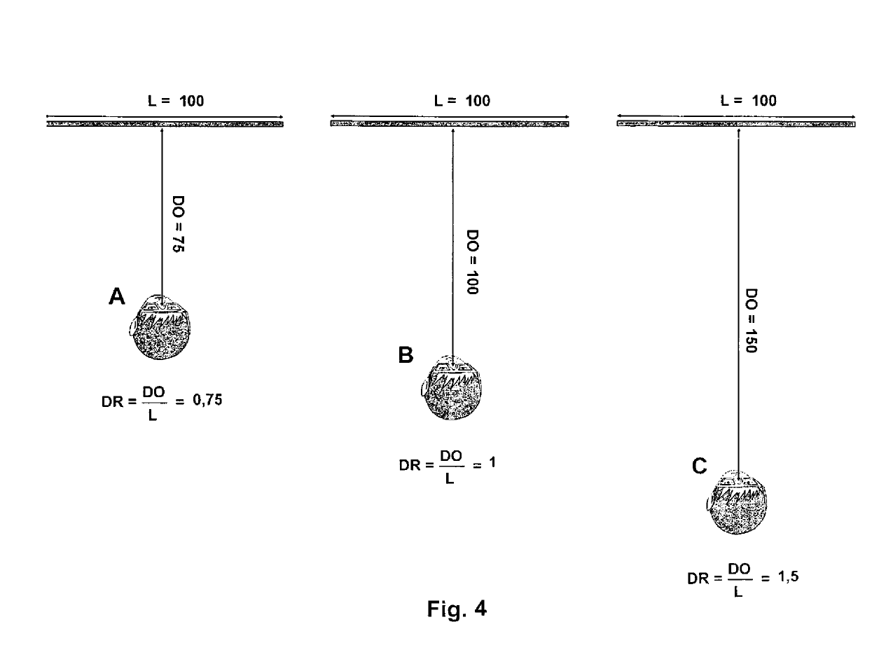

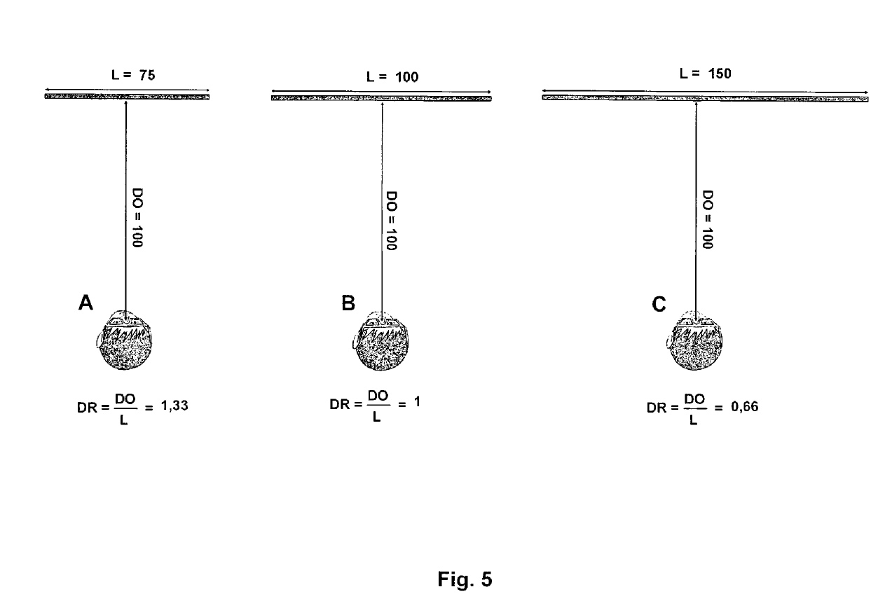

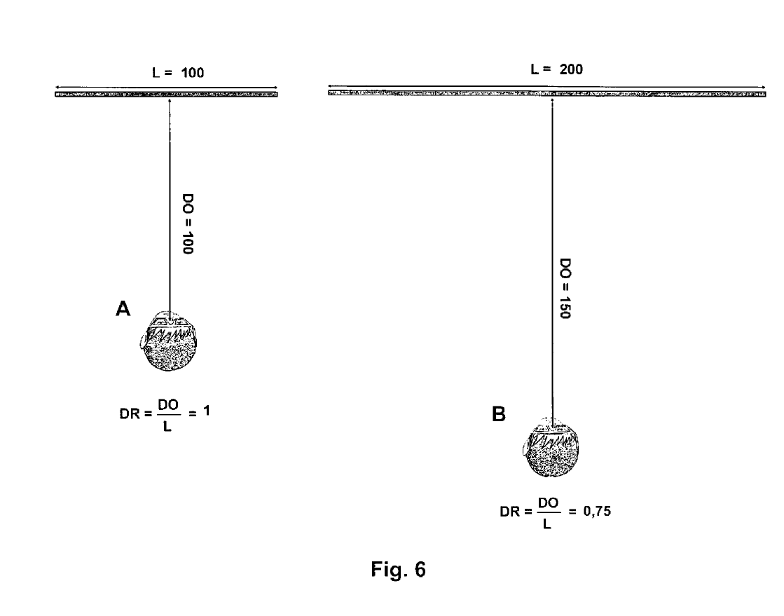

For an anti-ghost calibration achieved at a relative reference distance, the observer will perceive ghost image effects if he places himself at a relative distance of less than the relative reference distance. For example, if the selected relative reference distance is 1, the observers A of FIG. 4, C of FIG. 5 and B of FIG. 6, positioned at a too small relative distance, will distinguish ghost image effects all along the sequence. On the other hand, the observer may watch the sequence without perceiving any ghost image when he places himself at a relative distance greater than the relative reference distance. For example, if the selected relative reference distance is 1, the observers A, B and C of FIG. 3, B and C of FIG. 4, A and B of FIG. 5 and A of FIG. 6 are all positioned at a relative distance allowing them to perceive a pleasant sensation of relief without any ghost image effect all along the sequence. However, for an identical screen size, the relief sensation will disappear if the observer places himself at a relative distance much greater than the relative reference distance, for example ten times the relative reference distance. Finally, for a same anti-ghost calibration, observed at a same relative reference distance, the relief sensation will appear to be more significant on a large screen than on a smaller screen. Indeed, the interpupillary distance of the spectator remains constant while the size of the screen and therefore the displayed disparities change scale. For example in FIG. 3, the observer C will perceive a more spectacular relief sensation than spectators A and B. All these constraints should be taken into account upon selecting a relative reference distance before anti-ghost calibration.

Theoretically, there exists a different anti-ghost calibration for each possible relative distance. However, for example when in a cinema auditorium, spectators placed at different rows of armchairs are watching a same screen, one and only one relative reference distance which is satisfactory for all the spectators, will have to be selected. The latter will be used for the anti-ghost calibration of the whole sequence. The first row of spectators should then be preferably placed at the relative reference distance. In order to improve the sensation of relief for the whole of the spectators, the relative reference distance not corresponding the first row of armchairs, but corresponding to a few rows farther from the screen, may be selected during the anti-ghost calibration. In this case, it is preferable that the spectators do not occupy the first rows of armchairs located below the relative reference distance.

For immersive cinema auditoriums, for example IMAX (brand name) auditoriums, for which the relative distance of the first rows of armchairs is less than that of standard 35 mm type auditoriums, it is desirable to carry out a different anti-ghost calibration for these two auditorium profiles. The relative reference distance selected during said calibration will preferentially be comprised between 0.4 and 0.6 for said immersive auditoriums, and comprised between 0.8 and 1.2 for said standard auditoriums.

For the diffusion of a sequence on a DVD medium or via VoD (Video on Demand), the potential observation conditions are very varied, both as regards screen sizes and observation distances. It may therefore be contemplated to carry out several anti-ghost calibrations with different relative reference distances in order to cover a variety of possible observation situations. The spectator may then select from these different versions the one which is closest to his/her personal observation conditions. For example, three different versions of a same film may be proposed with the relative reference distances of 3, 5 and 7 for a utilization with a standard video definition (PAL, SECAM, NTSC) and of 1.5, 3 and 5 for a high definition utilization (1920×1080 pixels).

In every case, the relative reference distance which will be selected before the beginning of an anti-ghost calibration, will remain fixed for the whole duration of the sequence.

The operator responsible for anti-ghost calibration will position himself/herself in front of a monitoring screen at the selected relative reference distance. In order to properly evaluate the presence of visible ghost image effects or not, the screen used during said calibration will be of a contrast ratio and of a resolution comparable with the screen used by the final spectator. Also said filtering spectacles used during said calibration, will preferentially have a spectral transmission identical with that of the spectacles used by the final spectator. In the opposite case, there may be a variation between the relative reference distance selected during said calibration and the effective relative reference distance for the final spectator. In this case, the spectator perceiving the presence of ghost images, may alone adjust his/her positioning relatively to his/her screen, in order to find his/her relative reference distance, depending on his/her screen and/or on his/her spectacles, from which the ghost image effects disappear. In order to properly evaluate the relief sensation, the monitoring screen will as far as possible be of a size close to the size of the screen used by the final spectator (this parameter is not significant for evaluating ghost image effects).

D) Anti-Ghost Calibration Upon Shooting:

In the case when the anti-ghost calibration is carried out at the same time as the shooting of the sequences of pairs of stereoscopic images.

Notably:
during stereoscopic shooting of actual images with a camera system recording at least two different viewpoints, such as for example: a camera system with two distinct sensors, a mono-sensor camera with a mono-objective or bi-objective binocular separation.
during stereoscopic shooting of synthetic images (for example in a video game or in a cartoon film).

Depending on the possibilities, the anti-ghost calibration may be carried out simultaneously or before the colorimetric processing operations as described earlier. However, it is preferable to process the ghost image effects on color images which have been already corrected.

The question here is that the operator responsible for the anti-ghost calibration will act on the adjustments of the stereoscopic camera system in order to minimize below the perception threshold, the ghost images which may appear to any observer placed at a relative reference distance with respect to a viewing screen.

Said operator, having normal visual acuity without any colorimetric defect, equipped with said spectacles, placed at a selected relative reference distance from his/her monitoring screen, watches said single image which is constructed in real time from the right and left images captured by the camera system. He/she acts simultaneously or by successive approximation on the following adjustments numbered from 1 to 3:

1) Adjustment of the Convergence:

Said operator, seeing that ghost image effects are visible, then acts on the adjustment of the convergence in order to cancel on the single image the disparity at the maximum attention point of the filmed scene. On this maximum attention point, the ghost image sensation disappears while it is still present elsewhere in the single image (FIG. 10). Preferably, said production step further comprises adjustment of convergence in order to cancel the stereoscopic disparities at the maximum attention point. After this first adjustment, the operator may either act on the adjustment of the stereoscopic base, or on the adjustment of the depth of field, or on both by successive approximation or on both simultaneously. Determination of the maximum attention point may be considerably facilitated by any technique for tracking glance, also called eye tracking, on one or more control observers. This tracking of the glance may be carried out on a single eye or on both eyes of the observer, in this case the position of the maximum attention point will be known on each of the two images of the stereoscopic pair. In the case when the maximum attention point is determined manually, on a single image of said stereoscopic pair or by tracking the glance on a single eye, a photogrammetric computation, preferably in real time, may advantageously determine the homologous point of said maximum attention point in the other image of said pair. Once the maximum attention point is located on each of the two images of the stereoscopic pair, convergence may be performed automatically. Advantageously, it is proceeded with measurement by tracking the glance on at least one observer in order to determine the maximum attention point.

2) Adjustment of the Stereoscopic Base:

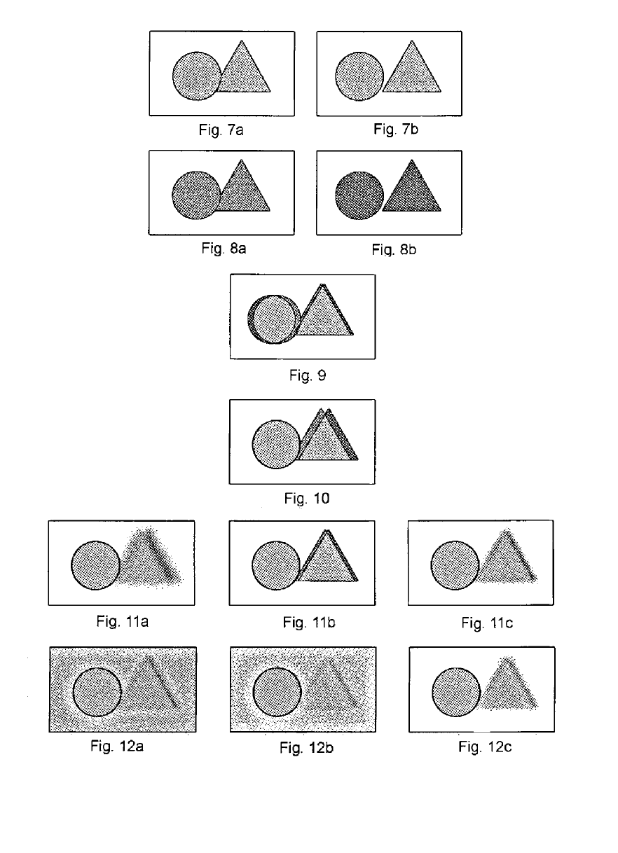

The operator reduces the adjustment of the stereoscopic base in order to minimize the ghost image effects still present (FIG. 11b). He/she may either minimize the effect of ghost images below his/her perception threshold, in which case the adjustments are finished for this single image, or leave a few ghost images and correct them subsequently by reducing the depth of field. The operator and/or an automatic procedure will act so that the distance between the camera system and the point of convergence of the optical axes does not vary when the stereoscopic base is modified. According to an embodiment, said production step further comprises adjustment of the stereoscopic base in order to minimize the maximum stereoscopic disparity in the sharpness areas. According to an alternative embodiment, said production step further comprises adjustment of the stereoscopic base in order to minimize, in the sharpness areas, the stereoscopic disparities below a value of:
6/1000 of the width of the images, for image sequences for which the horizontal resolution before setting size and display is less than 1,300 pixels,
4/1000 of the width of the images, for the image sequences, for which the horizontal resolution before setting size and display is greater than 1,299 pixels and/or for image sequences of the 35 m or 70 mm cinematographic projection type.

The operator may either reduce the stereoscopic base until minimization of the ghost image effect below his/her perception threshold in which case the adjustments are finished for said single image, or leave a few ghost images, to the benefit of a stereoscopic base providing a superior relief sensation, and to then minimize them by using adjustment no. 3.

3) Adjustment of the Depth of Field:

The operator adjusts the focusing of the shooting objectives on the maximum attention point and acts on the adjustment of the synchronized diaphragms of the objectives in order to reduce the depth of field in the single image (FIG. 11a and 11c). As adjustment of the exposure it determined by a compromise between the adjustment of the diaphragm, the selection of the sensitivity of the sensor or of the film, and the use of luminosity-lowering filter(s). In synthetic images or in video games, adjustment of the depth of field is often the result of calculations which simulate as close as possible the result which will be obtained with the diaphragm of an actual objective. This reduction in the depth of field increases blurring in the portions of the single image where the ghost images are visible and thus reduces their perception. The operator may, either minimize the effect of ghost images below his/her perception threshold in which case the adjustments will be finished for this single image, or leave a few ghost images and then correct them subsequently by reducing the stereoscopic base. Advantageously, said production step further comprises an adjustment of the depth of field in order to blur the stereoscopic disparity areas above a threshold value. According to another alternative embodiment, said production step further comprises an adjustment of the depth of field in order to blur the stereoscopic disparity areas above a value of more than:
6/1000 of the width of the images for image sequences for which the horizontal resolution before setting size and display is less than 1,300 pixels.
4/1000 of the width of the images for image sequences for which the horizontal resolution before setting size and display is larger than 1,299 pixels and/or for image sequences of the 35 mm or 70 mm cinematographic projection type.

The provided adjustments will depend both on artistic and technical choices.

E) Anti-Ghost Calibration after Shooting:

In the case when anti-ghost calibration is carried out after producing the sequence of pairs of stereoscopic images, it is proceeded in the following way:

Depending on the possibilities, the anti-ghost calibration may be carried out before, after or during the colorimetric processing operations described earlier. It is however preferable to process the ghost image effects on color images which have already been corrected.

Said operator, having normal visual acuity without any colorimetric defect, equipped with said spectacles, placed at the selected relative reference distance from his/her monitoring screen, looks at said single image which is constructed in real time from the right and left images of the pairs of stereoscopic images. In order to minimize the ghost image effects below the perception threshold, he/she proceeds according to the following steps numbered from 1 to 5:

1) Adjustment of Collimation:

Said operator, seeing that ghost image effects are visible, then adjusts collimation in order to cancel on the single image, the disparity of the maximum attention point of the filmed scene. On this maximum attention point, the ghost image sensation disappears while it is still present elsewhere in the single image (FIG. 10). Preferably, said production and/or construction step further comprises a collimation operation, locally and/or globally, in order to cancel the stereoscopic disparities at the maximum attention point. Determination of the maximum attention point required for adjusting collimation may be considerably facilitated by any technique for tracking the glance, also called eye tracking, on one or more control observers. This tracking of the glance may be performed on a single eye or on both eyes of the observer; in this case, the position of the maximum attention point will be recognized on each of the two images of the stereoscopic pair. In the case when the maximum attention point is determined by hand on a single image of said stereoscopic pair or by tracking the glance on a single eye, a photogrammetric computation, preferably in real time, may advantageously determine the homologous point of said maximum attention point in the other image of said pair. Once the maximum attention point is located on each of the two images of the stereoscopic pair, collimation may be performed automatically. Advantageously, it is proceeded with a measurement by tracking the glance on at least one observer in order to determine the maximum attention point.

2) Calculation of the Z Coordinates:

The adjustments nos. 3, 4 and 5 suppose that the coordinate Z of each pixel of each image of the stereoscopic pairs is available. Z corresponds to the horizontal stereoscopic disparity generally expressed as a fraction of pixels. Z may be negative or positive. Z is negative when the pixel is perceived in depth behind the plane of the screen or positive when the pixel is perceived as protruding out in front of the plane of the screen. In the case when the coordinate Z of certain pixels cannot be obtained (for example in an area where a detail is only visible on only one of the two images of a stereoscopic pair for example), it may be evaluated by any other known method, either manually or by calculation (for example, by extrapolating the Z value of a close image area with approaching luminosity, color, texture, sharpness, by shadow analysis or by time analysis of the sequence of images). Software packages such as Retimer (trade name) of RealViz or Twixtor (trade name) of Re-vision allow this information Z to be found in an acceptable way. In the case of films with synthetic images, Z may be directly obtained by the animation, modeling or rendering software package. After this step, the operator may act on the three following adjustments no. 3, no. 4, no. 5, either by successive approximation or simultaneously.

3) Virtual Adjustment of the Stereoscopic Base:

The adjustment of the stereoscopic base is reduced virtually in order to minimize the effects of ghost images still present (FIG. 11b). To do this, either one of the two images of the stereoscopic pair is retained and the second one will be calculated with a smaller stereoscopic base than the original one, or two new images will be calculated which will correspond to a smaller stereoscopic base than the original one. For example, if it is desired to modify the original stereoscopic base (BSO) and calculate a new virtual stereoscopic base (BSV) while retaining the right image, the virtual left image will be calculated by proceeding with the steps hereafter (the ratio between BSV and BVO is noted as F, i.e.: F=BSV/BSO):
an intermediate image (A) is calculated by assigning to it pixels of the right image individually and horizontally displaced by |Z/F| pixel(s) to the right if Z is positive or to the left if Z is negative. The thereby generated image (A) contains non-updated pixels. A zero value is assigned to the alpha layer of the latter (corresponding to total transparence) while the value 1 (corresponding to total opacity) is assigned to all the other pixels.
an intermediate image (B) is calculated by assigning to it the pixels of the left image, individually and horizontally displaced by |Z/1−F)| pixels to the left if Z is positive or to the right if Z is negative. The thereby generated image (B) contains non-updated pixels. A zero value (corresponding to total transparence) is assigned to the alpha layer of the latter) while the value F is assigned to all the other pixels.
the virtual left image corresponds to the superposition by transparence of both images (A) and (B).

According to an embodiment, said production and/or construction step further comprises the calculation, from pairs of stereoscopic images, of new pairs of images corresponding to a smaller stereoscopic base than the original stereoscopic base. Advantageously, one of the images of a new pair is one of the images of the original pair. According to another alternative embodiment, said production and/or construction step further comprises the calculation from pairs of stereoscopic images, of new pairs of images for which the maximum stereoscopic disparity is less than the maximum stereoscopic disparity of the original pair. Advantageously, one of the images of a new pair is one of the images of the original pair. According to another alternative embodiment, said production and/or construction step further comprises processing of the images consisting of reducing the stereoscopic disparities in order to obtain in the sharpness areas, stereoscopic disparities of less than a value of:
6/1000 of the width of the images, for image sequences for which the horizontal resolution before setting size and display is less than 1,300 pixels.
4/1000 of the width of the images, for image sequences for which the horizontal resolution before setting size and display is greater than 1,299 pixels and/or for image sequences of the 35 mm or 70 mm cinematographic projection type.

Advantageously, one of the images of a new pair is one of the images of the original pair. According to another embodiment, the images of the original pair are synthetic images.

In the particular case of an image sequence in two dimensions extruded to three dimensions (2D-3D conversion) during postproduction, the coordinate Z of each pixel is generated or obtained by any known method, either manually and/or by calculation (for example by time analysis of the displacement of the pixels if the camera is moved and/or by segmentation of the image followed by an analysis of the shadows, of the sharpness, of the luminosity of the segments). Next, the second image of the stereoscopic pair is calculated by carrying out for each pixel of the initial image, a horizontal displacement depending on Z and on the desired stereoscopic base. Next the non-updated pixel areas of the new image are filled with any known method, either manually and/or by calculation (for example by duplicating a neighboring area, by reinterpreting a neighboring area (inpainting), by time-searching for the area to be filled). According to an embodiment, said production step further consists of converting a sequence of two-dimensional images into pairs of stereoscopic images by a 3D extruding operation. Advantageously, the maximum stereoscopic disparity of said pairs, in the sharpness areas is less than a value of:
6/1000 of the width of the images, for image sequences for which the horizontal resolution before setting size and display is less than 1,300 pixels.
4/1000 of the width of the images, for image sequences for which the horizontal resolution before setting of size and display is larger than 1,299 pixels and/or for image sequences of the 35 mm or 70 mm cinematographic projection type.

According to another embodiment, the second image of the stereoscopic pair is calculated by carrying out for certain elements of the image, horizontal displacement depending on stereoscopic bases which differ from each other. The operator may either reduce the stereoscopic base until minimization of the ghost image effect below his/her perception threshold in which case the adjustments are finished for said single image, or leave a few ghost images, to the benefit of a stereoscopic base providing a superior relief sensation, and then minimizing them by using adjustments no. 4 or no. 5.

4) Adjustment of the Blurring:

Via a software procedure, the operator adds blurring in agreement with artistic supervision, on the left and right images, into the portions where ghost image effects are visible (FIGS. 11a and 11c). Blurring is applied as a function of the coordinates Z of each pixel, generally with an intensity proportional to the absolute value of Z, advantageously simulating a small depth of field, and/or the blurring is applied on one or more areas selected by hand.

There exist different known techniques and easily adaptable for generating software blurring, for example Gaussian blurring or bicubic blurring. According to an embodiment, said production and/or construction step further comprises local processing of the images consisting of blurring the stereoscopic disparity areas. Advantageously, the blurring intensity increases with the stereoscopic disparity. According to another embodiment, said production and/or construction step further comprises local processing of the images consisting of blurring the areas with stereoscopic disparities above a threshold value. Advantageously, said threshold value is less than 6/1000 of the width of the images, for image sequences, the horizontal resolution of which before setting to size and display is less than 1,300 pixels. Advantageously, said threshold value is less than 4/1000 of the width of the images, for image sequences, the horizontal resolution of which before setting to size and display is greater than 1,299 pixels and/or for image sequences of the 35 mm or 70 mm cinematographic projection type. Advantageously, the blurring intensity increases with stereoscopic disparity. The operator may, either minimize the effect of ghost images below his/her perception threshold, in which case the adjustments are finished for said single image, or leave a few ghost images and correct them subsequently with adjustments no. 3 or no. 5.

5) Lowering the Light Contrast:

The operator reduces the light contrast (i.e. the difference between the brightest points and the darkest points), on the left and right images before constructing said single image, in the portions where stereoscopic disparity causes ghost images. In order to delimit the areas which should be acted upon, he/she may use the coordinates Z and/or manually select one or more areas. In agreement with the artistic supervision, reduction of the contrast may be accomplished by darkening the bright pixels and/or brightening the dark pixels. Advantageously, he/she will modulate the light contrast in a non-linear way by specifically adjusting the luminosity transfer curve of the image. For example in FIG. 12a, it is possible to see the effects of a light contrast correction by darkening of the bright and remove areas; in FIG. 12c, the light contrast correction is applied by brightening dark and remote areas; in FIG. 12b, the contrast correction is a compromise between the adjustments of FIGS. 12a and 12c. This light contrast reduction will gain credibility if it may be assimilated to atmospheric diffusion which involves parameterization of its intensity depending on the Z coordinates. According to an embodiment, said production and/or construction step further comprises local processing of the images consisting of changing the light contrast in the stereoscopic disparity areas above a threshold value. Advantageously, the intensity of the change in the contrast increases with the disparity. Advantageously, said threshold value is less than:
6/1000 of the width of the images, for image sequences for which the horizontal resolution before setting size and display is less than 1,300 pixels.
4/1000 of the width of the images, for image sequences for which the horizontal resolution before setting size and display is larger than 1,299 pixels and/or for image sequences of the 35 mm or 70 mm cinematographic projection type.

Advantageously, the intensity of the change in the contrast increases with disparity. The operator may either minimize the effect of ghost images below his/her perception threshold in which case the adjustments will be finished for said single image, or leave a few ghost images and correct them subsequently with adjustments no. 3 or no. 4.

The different adjustments nos. 1, 3, 4, 5 may be modified for each pair of images of the sequence every time that this will be necessary for preserving this minimization of the perception of the ghost image effect at a selected relative reference distance.

In order not to have to manually parameterize all the adjustments required for each image, the operator will use for each shot of the sequence, the capability provided by the video processing software packages, of interpolating the adjustments between two reference key points which he/she will have himself/herself parameterized.

The provided adjustments will depend on both artistic and technical choices.

F) Automated Anti-Ghost Calibration:

It is not always possible for the operator to carry out an anti-ghost calibration on an image sequence. This is the case for example in a video game or during the filming of a live sports broadcast where the shooting conditions change too rapidly. In these cases, it will advantageously be possible to set rules of conduct in the form of software procedures aiming at simulating at best the decisions of an operator.

As an indication, here is a procedure for automated stereoscopic adjustments according to the invention. The latter is applicable both in the field of video games and in that of cartoon films or the filming of actual images. The goal is to automatically calculate the stereoscopic base in order to limit the stereoscopic disparity by a maximum value Dn, for the (sharp) pixel areas which will not be blurred and by a maximum value Df for the pixel areas which will be blurred. Df and Dn are relative values, measured as a fraction of the image width, they will have been determined beforehand by the film-maker or the operator depending on a desired relative reference distance and on the intensity of the blurring which will be applied. Let us specify that if blurring is not used in the adjustments, Df is equivalent to Dn, and that in the opposite case, Df is greater than Dn. The distance D1 separating the point of convergence of the optical axes (or its equivalent by collimation) of the shooting camera system is also known, said point of convergence having been determined beforehand, either by the film-maker/operator (depending on the maximum attention point) or by the operation already described for tracking the glance of one or more observers (depending on the maximum attention point). Finally, the horizontal field angle β of the objectives of the shooting camera system is known. The following steps describe the whole procedure:
a software procedure determines the distance d2 separating the most remote shot of the filmed scene and the shooting camera system. In the case of actual shooting, the depth of each pixel will be determined beforehand as a function of their disparity calculated by digital photogrammetry.
a software procedure determines the distance d3 separating the closest shot of the filmed scene and the shooting camera system. In the case of actual shooting, the depth of each pixel will be determined beforehand as a function of their disparity calculated by digital photogrammetry.
the stereoscopic base BS1 required for the calculation or for capturing a pair of stereoscopic images for which the maximum disparity of the pixels is found in a depth equivalent to Df pixels, is calculated as:

BS1=(2.tan(β/2).Df.d1.d2)/d2−d1)
the stereoscopic base BS2 required for calculating or capturing a pair of stereoscopic images for which the maximum disparities of the pixels is found in protrusion is equivalent to Df pixels:

BS2=(2.tan(β/2).Df.d3.d1)/(d1−d3)
a pair of stereoscopic images is calculated or captured depending on a stereoscopic base corresponding to the smallest value among BS1 and BS2. The convergence point (or its equivalent by collimation) will be the distance d1 (or its equivalent in disparity).
the pixels with a stereoscopic disparity greater than Dn will be blurred in each of the images of the stereoscopic pair with an intensity, depending on their distance from Dn.
the single image is constructed and displayed.
the whole of these steps is again applied for displaying the following image.

It should be noted that certain video games may accommodate a reduced depth of field while others not. The role of the film director of the video game is then determining, for dosing the selection between minimizing the stereoscopic base and minimizing the depth of field. He/she is also responsible for determining the point of convergence of the optical axes (or its equivalent in collimation), i.e. the maximum attention point during the whole course of the game. The player may possibly himself/herself select the relative reference distance which he/she would like to occupy relatively to his/her screen, which will modify according to a procedure, the stereoscopic base and/or the depth of field depending on the staging guide lines from the film director.

According to an embodiment, said production and/or construction step further comprises a computer program which, loaded and executed by a computer system, modifies without any intervention from a human operator, locally and/or globally, at least one of the parameters formed by the stereoscopic disparity, the sharpness, the blurring and the light contrast, depending on the changes of at least one of the distances between the shooting camera system, the subject of the foreground and the most distant shot of the filmed scene. Advantageously, a computer program, loaded and executed by a computer system, allows the final observer and/or the spectator and/or the player, to modify the parameterization of the stereoscopic base and/or the local blurring and/or colorimetry.

According to another embodiment, the images are interactive synthetic images and/or video game images generated by a computer program, loaded and executed by a computer system. Advantageously, with a computer program, loaded and executed by a computer system, the final observer and/or the spectator and/or the player is able to modify the parameterization of the stereoscopic base and/or the local blurring and/or colorimetry.

G) Other Characteristics of the Invention:

The invention also relates to an assembly for viewing a sequence of stereoscopic images according to the aforementioned method, characterized in that it is formed by a medium for recording said sequence of images and a plurality of spectacles according to the invention each comprising pairs of different filters allowing observation of said sequence at different relative reference distances and/or different colorimetric renderings.

The invention further relates to spectacles for observing a sequence of viewed stereoscopic images according to the aforementioned method, characterized in that they include a first filter, function of the chromatic components of said first chromatic filtering, and a second filter, function of the chromatic components of said second chromatic filtering, at least one of the filters comprises a small proportion of the chromatic components of the other filter and in that said spectacles have characteristics compliant with the aforementioned method.

The invention also relates to a recording medium and/or signal transmission and/or a service for transmitting an image sequence on demand, characterized in that it includes a sequence of images produced according to the aforementioned method.

The invention further relates to a recording medium and/or signal transmission and/or a service for transmitting an image sequence on demand, characterized in that it includes a plurality of versions of a same sequence, each of said versions being an image sequence produced according to the aforementioned method, each of said versions having at least one different parameterization of the stereoscopic disparity and/or of the local blurring and/or of the local light contrast and/or of colorimetry.

Advantageously, the recording medium and/or signal transmission and/or a service for transmitting an image sequence on demand, characterized in that it includes a computer program allowing application of the aforementioned method when this program is loaded and executed by a computer system.

The invention also relates to a sequence of stereoscopic images broadcasted in a cinema auditorium, according to the aforementioned method, characterized in that said sequence is broadcasted with smaller maximum stereoscopic disparity in auditoriums using said method than in other auditoriums using stereoscopic viewing methods which do not involve filters comprising a spectral transmission with predominance of a color.

Advantageously, said sequence is broadcasted with a smaller depth of field in auditoriums using said method than in other auditoriums using stereoscopic viewing methods which do not involve filters comprising a spectral transmission with predominance of a color.

Preferably, said sequence is broadcasted with a smaller maximum stereoscopic disparity on said recording medium and/or said signal transmission and/or said service for transmitting a sequence of images on demand, than in cinema auditoriums using stereoscopic viewing methods which do not involve filters comprising a spectral transmission with predominance of a color.

Advantageously, said sequence is broadcasted with a smaller depth of field on said recording medium and/or said signal transmission and/or said service for transmitting a sequence of images upon demand, than in cinema auditoriums using stereoscopic viewing methods not involving filters comprising a spectral transmission with predominance of a color.

1. A method for viewing a sequence of images producing a relief sensation, including a step for producing a sequence of pairs of stereoscopic images, a step for constructing a sequence of single images consisting of calculating from each of said stereoscopic image pairs, a viewing image which superposes by additive synthesis the first image to which is applied chromatic filtering and the second image to which is applied chromatic filtering complementary to the first filtering, a step for displaying on a viewing screen, said viewing screen being observed through spectacles including a first filter, depending on the chromatic components of said first chromatic filtering, and a second filter, depending on the chromatic components of said second chromatic filtering, at least one of the filters transmits a small proportion of the chromatic components of the other filter, wherein said sequence of pairs of stereoscopic images represent a diversity of filmed situations where at least one of the distances between the shooting camera system, the foreground subject and the most distant shot varies, and in that said production and/or construction step further comprises, for each of the pairs of stereoscopic images of said sequence, by adjustment and/or by calculation, local and/or global adjustment, on at least one of the parameters formed by stereoscopic disparity, sharpness, blurring and light contrast, in order to minimize the ghost image effects below the perception threshold of the observer equipped with said filtering spectacles when said observer, watching said sequence of single images, is placed at a relative reference distance below which ghost image effects appear, said relative reference distance being substantially constant for the whole duration of said sequence, said observer having good visual acuity, without any colorimetric defect.

2. The method of claim 1, wherein one of the filters of said spectacles is a filter comprising a spectral transmission with predominance of green and the other filter is a filter comprising a spectral transmission with predominance of magenta.

3. The method of claim 1, wherein one of the filters of said spectacles is a filter comprising a spectral transmission with predominance of cyan and the other filter is a filter comprising a spectral transmission with predominance of red.

4. The method of claim 1, wherein one of the filters of said spectacles comprises a spectral transmission in the area about 620 nm or in the area of 520 nm representing 5% to 18% of the transmission of the opposite filter in the same area.

5. (canceled)

6. The method of claim 1, wherein each of the filters transmits a small proportion of the chromatic components of the other filter.

7. The method of claim 1, wherein the spectral transmission curve of each of the filters of said spectacles substantially corresponds to FIG. 1, or to FIG. 2 or to FIG. 3.

8. (canceled)

9. (canceled)

10. The method of claim 1, wherein said production and/or construction step further comprises a collimation operation locally and/or globally, in order to cancel the stereoscopic disparities at the maximum attention point.

11. The method of claim 1, wherein the step for producing further comprises an adjustment of convergence in order to cancel the stereoscopic disparities at the maximum attention point.

12. The method of claim 1, wherein it is further proceeded with measurement by tracking the glance on at least one observer in order to determine the maximum attention point.

13. The method of claim 1, wherein said production and/or construction step further comprises local processing of the images consisting of blurring the areas of stereoscopic disparity above a threshold value.

14. (canceled)

15. (canceled)

16. The method of claim 10, wherein the intensity of the blurring increases with stereoscopic disparity.

17. The method of claim 1, wherein said production step further comprises an adjustment of the depth of field in order to blur the areas with stereoscopic disparity above a threshold value.

18. (canceled)

19. (canceled)

20. The method of claim 1, wherein said production and/or construction step further comprises local processing of the images consisting of modifying the light contrast in the areas of stereoscopic disparity above a threshold value.

21. (canceled)

22. (canceled)

23. The method of claim 1, wherein the intensity of the change in the contrast increases with disparity.

24. The method of claim 1, wherein said production step further comprises converting a sequence of two-dimensional images into pairs of stereoscopic images by a 3D extruding operation.

25. (canceled)

26. (canceled)

27. The method of claim 1, wherein said production and/or construction step further comprises calculation, from pairs of stereoscopic images, of new pairs of images corresponding to a smaller stereoscopic base than the original stereoscopic base.

28. The method of claim 1, wherein said production and/or construction step further comprises the calculation, from pairs of stereoscopic images, of new pairs of images, the maximum stereoscopic disparity of which is less than the maximum stereoscopic disparity of the original pair.

29. The method of claim 1, wherein said production and/or construction step further comprises processing of the images consisting of reducing the stereoscopic disparities in order to obtain in the sharpness areas, stereoscopic disparities below a threshold value.

30. (canceled)

31. The method of claims 16, wherein one of the images of a new pair is one of the images of the original pair.

32. The method of claim 1, wherein said production step further comprises the adjustment of the stereoscopic base in order to minimize, in the sharpness areas, the maximum stereoscopic disparity.

33. The method of claim 1, wherein said production step further comprises the adjustment of the stereoscopic base in order to minimize, the sharpness areas, the stereoscopic disparities below a threshold value.

34. (canceled)

35. The method of claim 1, wherein the images of the original pair are synthetic images.

36. (canceled)

37. The method of claim 1, wherein the images are interactive synthesis images and/or video game images generated by a computer program, loaded and executed by a computer system.

38. (canceled)

39. The method of claim 1, wherein said production and/or construction step further includes a non-linear colorimetric correction in order to find again after construction of said sequence of single images, with said spectacles, a perception of colors as close as possible to those visible without said spectacles, on the two-dimensional version of the original images.

40. The method of claim 1, wherein said production and/or construction step further includes colorimetric correction of certain colors aiming at reducing their saturation and/or modifying their hue and/or modifying their luminosity in order to make them more comfortable to look at after building said sequence of single images, with said spectacles.

41. An assembly for viewing a sequence of stereoscopic images according to the method, of claim 1, wherein said assembly is formed by a medium for recording said sequence of images and a plurality of spectacles, each of the spectacles comprising pairs of different filters allowing observation of said sequence at different relative reference distances and/or different colorimetric renderings.

42. Spectacles for observing a sequence of stereoscopic images viewed according to the method of claim 1, wherein said spectacles include a first filter, a function of the chromatic components of said first chromatic filtering, and a second filter, a function of the chromatic components of said second chromatic filtering, at least one of the filters comprises a small portion of chromatic components of the other filter.

43. The spectacles of claim 42, wherein one of the filters of said spectacles is a filter comprising a spectacle transmission with predominance of green and the other filter is a filter comprising a spectral transmission with predominance of magenta.

44. The spectacles of claim 42, wherein one of the filters of said spectacles is a filter comprising a spectral transmission with predominance of cyan and the other filter is a filter comprising a spectral transmission with predominance of red.

45. The spectacles of claim 42, wherein one of the filters of said spectacles comprises a spectral transmission in the area around 620 nm representing 5% to 18% of the transmission of the opposite filter in the same area.

46. (canceled)

47. The spectacles of claim 42, wherein each of the filters transmits a small proportion of the chromatic components of the other filter.

48. The spectacles of claim 42, wherein the spectral transmission curve of each of the filters of said spectacles substantially corresponds to FIG. 1 or to FIG. 2 or to FIG. 3.

49. (canceled)

50. (canceled)

51. A recording medium and/or signal transmission and/or service for transmitting an image sequence on demand, comprising an image sequence produced according to the method of claim 1.

52. (canceled)

53. A recording medium and/or signal transmission and/or service for transmitting a computer program on demand, comprising a computer program allowing application of a method according to claim 1, when this program is loaded and executed on a computer system.

54. A sequence of stereoscopic images broadcasted in a cinema auditorium according to a method in accordance with claim 1, wherein said sequence is broadcasted with a smaller maximum stereoscopic disparity or a smaller depth of field in auditoriums using said method than in other auditoriums using stereoscopic viewing methods not involving filters comprising a spectral transmission with predominance of a color.

55. (canceled)

56. A sequence of stereoscopic images broadcasted on a recording medium and/or service for transmission an image sequence on demand, according to a method in accordance with claim 1, wherein said sequence is broadcast with a smaller maximum stereoscopic disparity or a smaller depth of field on said medium and/or said transmission and/or said service, than in cinema auditoriums using stereoscopic viewing methods not involving filters comprising a spectral transmission with predominance of a color.

57. (canceled)
